(19) United States
(12) Patent Application Publication
(10) Pub. No.: US 2020/0204351 A1
(43) Pub. Date: Jun. 25, 2020

(54) METHOD FOR INFORMATION CONFIRMATION IN DISTRIBUTED SYSTEMS USING HYBRID BYZANTINE AGREEMENT

(71) Applicant: COBINHOOD LTD., Taipei City (TW)

(72) Inventors: Tai-Yuan CHEN, Taipei City (TW); Wei-Ning HUANG, Taipei City (TW); Po-Chun KUO, Taipei City (TW); Hao CHUNG, Taipei City (TW)

(21) Appl. No.: 16/725,006

(22) Filed: Dec. 23, 2019

Related U.S. Application Data
(60) Provisional application No. 62/784,600, filed on Dec. 24, 2018.

(51) Int. Cl. H04L 9/06; H04L 9/32; G06F 11/18; H04L 29/06

(52) U.S. Cl. CPC H04L 9/0643; H04L 9/3247; H04L 2209/38; H04L 63/1458; G06F 11/187

(57) ABSTRACT

A method for building agreements among a plurality of nodes in a distributed system to improve the throughput of the distributed system is disclosed. The method comprises performing a first Byzantine Agreement protocol; selecting a first leader node from the plurality of nodes; broadcasting a fast message from the first leader node to all other nodes when a clock is equal to 0; determining whether the first leader node decides a block according to a number of a plurality of fast-vote messages received from all other nodes by the first leader node and a value of the clock; and performing a second Byzantine Agreement protocol if it is determined that the first leader node cannot decide a block.

### CROSS-REFERENCE TO RELATED APPLICATION

This application claims the benefit of U.S. Provisional Patent Application Ser. No. 62/784,600, filed on Dec. 24, 2018, the entirety of which is incorporated herein by reference.

### BACKGROUND OF THE INVENTION

### 1. Field of the Invention

This invention relates to a distributed system, and, more particularly, to a method for building agreements among a plurality of nodes in the distributed system.

### 2. Description of Related Art

In 1982, Lamport et al. introduced a Byzantine General Problem which describes a situation where several generals want to make a consensus on whether they should attack or not, while some of them may be malicious. The method that solves the Byzantine General Problem is called a Byzantine agreement (BA).

In 2008, Nakamoto introduced a Byzantine Agreement (BA) which implements a Proof-of-Work (PoW) protocol to create distributed users' consensus. Users participating in the distributed system, also called as a blockchain, who solve mathematical puzzles first may generate next block and receive rewards. Meanwhile, users also validate transaction legitimacy to prevent from double spending. However, it suffers a latency of approximately one hour for reducing forks and needs big amount of computer calculations with consuming big amount of electricity as users have to compete to win the race and reach consensus.

In order to save electricity and balance decentralization, performance and safety of a distributed system, some other consensus protocols are proposed, such as Proof-of-Stake (PoS) Delegated Proof-of-Stake (DPoS) and so on. In 2017, Larimer et al. introduced EOS system using a DPoS protocol for reaching consensus. However, EOS system is operated with only 21 supernodes, not so decentralized and vulnerable to Distributed Denial-of-Service (DDoS) attacks. Besides, in 2016, Gilad et al. introduced an Algorand system using a Byzantine agreement by adopting a pure Proof-of-Stack (PoS) protocol. The Algorand system is characterized by that each new block is generated by a separate, new committee, randomly selected from all users. Later, Chen et al. introduced “ALGORAND AGREEMEN: Super Fast and Partition Resilient Byzantine Agreement” IACR Cryptology ePrint Archive, 2018:377, 2018, and its whole content is incorporated herein by reference. The modified Algorand system achieves fast agreement in a synchronous network, upholds safety in an asynchronous network, and recovers from any partition rapidly. Such an Algorand system is decentralized and has robust safety, but its throughput is limited.

### SUMMARY OF THE INVENTION

It is therefore an object of the present invention to provide a method for building agreements among a plurality of nodes in a distributed system to improve the throughput of the distributed system. The method comprises performing a first Byzantine Agreement protocol; selecting a first leader node from the plurality of nodes; broadcasting a fast message from the first leader node to all other nodes when a clock is equal to 0; determining whether the first leader node decides a block according to a number of a plurality of fast-vote messages received from all other nodes by the first leader node and a value of the clock; and performing a second Byzantine Agreement protocol if it is determined that the first leader node cannot decide a block.

In one aspect of the method described in the present invention, the first Byzantine Agreement protocol has a lower DDoS-resistance capacity and the second Byzantine Agreement protocol has a higher DDoS-resistance capacity.

In another aspect of the method described in the present invention, the first leader node is q^{th} node of the plurality of nodes, where q=Hash(Rᵢ, chain_{id}, height) mod N, where Rᵢ is a common reference string (CRS) at epoch i, chain is a series of chain name segments, and height is a block height.

In another aspect of the method described in the present invention, it is determined that the first leader node decides a block if the number of the plurality of fast-vote messages received by the first leader node amounts to 2tₘₐₓ+1 and the value of the clock is less than or equal to 3λ, where tₘₐₓ is a maximum size of malicious nodes, and λ is a upper bound of gossip time between two honest nodes.

In another aspect of the method described in the present invention, it is determined that another of the plurality of nodes decides a block if the number of the plurality of fast-vote messages received by the another of the plurality of nodes amount to 2tₘₐₓ+1 and the value of the clock is less than or equal to 3λ, where tₘₐₓ is a maximum size of malicious nodes, and λ, is a upper bound of gossip time between two honest nodes.

In another aspect of the method described in the present invention, the step of performing the second Byzantine Agreement protocol further comprises: having each one of the plurality of nodes have a plurality of internal variables, wherein the internal variables comprise r_{q}, lockvalue_{q}, lockround_{q} and clock_{q}, where r_{q} is an index of round at which a node q is working, lockvalue_{q} is candidate values that the node q supports, lockround_{q} is an index of round from which lockvalue_{q} comes and clock_{q} is a local clock of node q; initializing respectively r_{q} as 1, lockvalue_{q} as ⊥, lockround_{q} as 0 and clock_{q} as 0, where ⊥ is a value not in a set of values that can be decided; selecting a second leader node from the plurality of nodes; having each one of the plurality of nodes broadcast an initial message to all other nodes when clock_{q} is equal to 0; having each one of the plurality of nodes verify and compute the initial messages and broadcast a pre-commit message to all other nodes when clock_{q} is equal to 2λ, where λ is a upper bound of gossip time between two honest nodes; and confirming whether the number of the pre-commit messages received by the one of the plurality of nodes amounts to 2tₘₐₓ+1 and one of variables included in the plurality of pre-commit messages is equal to Rᵢ when clock_{q} is equal to 4λ, where tₘₐₓ is a maximum size of malicious nodes and Rᵢ is a common reference string (CRS) at epoch i; wherein the one of the plurality of nodes sets lockvalue_{q} as v and lockround_{q} as r_{q}, and broadcasts a commit message to all other nodes when clock_{q} is equal to 42 if the number of the plurality of pre-commit messages received by the one of the plurality of nodes amount to 2tₘₐₓ+1 and one of variables included by the plurality of pre-commit messages is equal to Rᵢ.

In another aspect of the method described in the present invention, the second leader node L is defined as:

$$L = {arg min}_{j ∈ {U}_{q}} \vert {R}_{i} - Hash ( {σ}_{j} ) \vert ,$$

where U_{q} is the set of nodes whose signatures are valid and σⱼ is a signature of status of the block, including some public predictable information, using a secret key of node j.

In another aspect of the method described in the present invention, the method further comprises terminating the second Byzantine Agreement protocol and supporting the block decided by the first Byzantine Agreement protocol when a valid proof of decision in the first Byzantine Agreement protocol is received after the second Byzantine Agreement protocol is performed.

In another aspect of the method described in the present invention, the method further comprises sending notarizing information which is a threshold signature signed by 2tₘₐₓ+1 nodes concurrently in a commit phase.

It is another object of present invention to provide a distributed system the throughput of which is improved. The distributed system comprises a plurality of nodes, wherein the plurality of nodes are configured to: selecting a first leader node from the plurality of nodes according to a first Byzantine Agreement protocol, broadcasting a fast message from the first leader node to all other nodes when a clock is equal to 0; receiving fast-vote messages from all other nodes at the first leader node; deciding a block by the first leader node according to a number of the plurality of fast-vote messages and a value of the clock; and performing a second Byzantine Agreement protocol if the first leader node cannot decide a block.

In one aspect of the distributed system described in the present invention, the first Byzantine Agreement protocol has a lower DDoS-resistance capacity and the second Byzantine Agreement protocol has a higher DDoS-resistance capacity.

In one aspect of the distributed system described in the present invention, the first leader node is q^{th} node of the plurality of nodes, where q=Hash(Rᵢ, chain_{id}, height) mod N, where Rᵢ is a common reference string (CRS) at epoch i, chain_{id} is a series of chain name segments, and height is a block height.

In one aspect of the distributed system described in the present invention, the plurality of nodes are further configured to: terminating the second Byzantine Agreement protocol and supporting the block decided by the first Byzantine Agreement protocol when a valid proof of decision in the first Byzantine Agreement protocol is received after the second Byzantine Agreement protocol is performed.

In one aspect of the distributed system described in the present invention, the plurality of nodes are further configured to: sending notarizing information which is a threshold signature signed by 2tₘₐₓ+1 nodes concurrently in a commit phase.

These and other features and advantages of the present invention can be more readily understood from the following preferred embodiments of the present invention with reference to the appended drawings.

### BRIEF DESCRIPTION OF THE DRAWINGS

In order to sufficiently understand the essence, advantages and the preferred embodiments of the present invention, the following detailed description will be more clearly understood by referring to the accompanying drawings.

FIG. 1 is a block diagram of a distributed system according to one embodiment of the present invention.

FIG. 2 is a communication flow of fast mode according to one embodiment of the present invention.

### DETAILED DESCRIPTION OF THE DRAWINGS

The following description shows the preferred embodiments of the present invention. The present invention is described below by referring to the embodiments and the figures. Thus, the present invention is not intended to be limited to the embodiments shown, but is to be accorded the principles disclosed herein. Furthermore, that various modifications or changes in light thereof will be suggested to persons skilled in the art and are to be included within the spirit and purview of this application and scope of the appended claims.

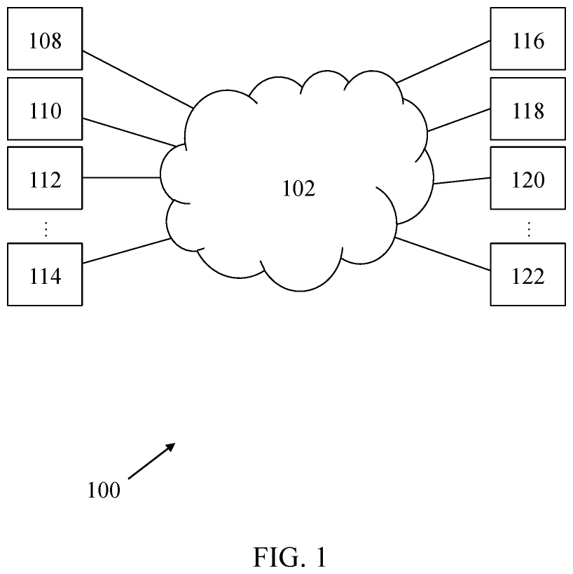

FIG. 1 is a diagram that shows a plurality of nodes 108-122 (e.g., individual personal computing devices, server computing devices, or other devices that have sufficient processor and storage abilities to participate in the system) connected to an internet 102 and connected to each other via the internet 102. The distributed system 100 in which transactions and records are organized in blocks includes the plurality of nodes 108-122. A first leader node is selected from the plurality of nodes 108-122 according to a first Byzantine Agreement protocol or a fast Byzantine Agreement protocol. The first leader node will broadcast a fast message all other nodes when the clock of the distributed system 100 is equal to 0. Then, he receives fast-vote messages from all other nodes, and is allowed to decide a block according to the amount of the plurality of fast-vote messages and the value of the clock. However, if the first leader node cannot decide a block, the system 100 performs a second Byzantine Agreement protocol or Algorand's Byzantine Agreement protocol. As will be understood by those skilled in the art, the present invention is applicable to all distributed computing environments and is not intended to be limited in any way by the exemplary distributed system of FIG. 1, which has been simplified for presentation purposes.

Algorand system adopts fully sortition which limits the throughput but is DDoS-resistance. In fact, network is not always attacked and has some degree of attack tolerance. It seems that there is no need to apply fully sortition in whole procedures.

It is, therefore, a Hybrid Byzantine Agreement protocol is proposed to improve the throughput of the distributed system. There is a Fast Byzantine Agreement protocol and a Robust Byzantine Agreement protocol cooperated with each other in the Hybrid Byzantine Agreement protocol. Briefly speaking, a leader is selected in a deterministic way and if the leader does not propose a value because of network attacks or delay caused by some other reasons, other nodes start a Robust Byzantine Agreement, i.e., selecting a leader based on a deterministic way initially helps reach high throughput (also called as a Fast mode) and selecting a leader based on fully sortition helps achieve high safety, such as DDoS-resistance (also called as a Safe mode).

In other words, if the network operates normally, all users agree on the pre-determined proposers block. Thus, only one user needs to propose the block for each round, so the bandwidth complexity is low. On the other hand, if the pre-determined proposer crashes, other users still can reach an agreement by entering the Safe mode. In this aspect, the Hybrid Byzantine Agreement protocol avoids the single point of failure and resists to the DDoS attack.

Details will be illustrated accompanying with Figures now. Notations are defined as below first.

### Notations

S: all nodes in the distributed system

n: the size of S

B: Block

L: leader

t: malicious nodes

n−t: size of correct nodes

tₘₐₓ: the maximum size of malicious nodes, which is equal to [(n−1)/3]

r_{q}: the index of the round at which node q is working

lockvalue_{q}: the candidate value that node q supports

lockround_{q}: the index of the round from which lockvalue_{q} comes

Rᵢ: common reference string (CRS) at epoch i

clock_{q}: local clock of node q

V: the set of values that can be decided

⊥: a value not in V

SKIP: a value not in V

λ: the upper bound of gossip time between two honest (correct) nodes in the distributed system

chain_{id}: a series of chain name segments

height: block height

weakly-synchronous: messages gossiping between any two correct nodes in the distributed system are less than 2

partitioned network: network where messages gossiping between any two correct nodes in the distributed system maybe exceed 2

sk_{q}: the secret key of node q, and qϵS

pk_{q}: the public key of node q, and qϵS

### Hybrid Byzantine Agreement

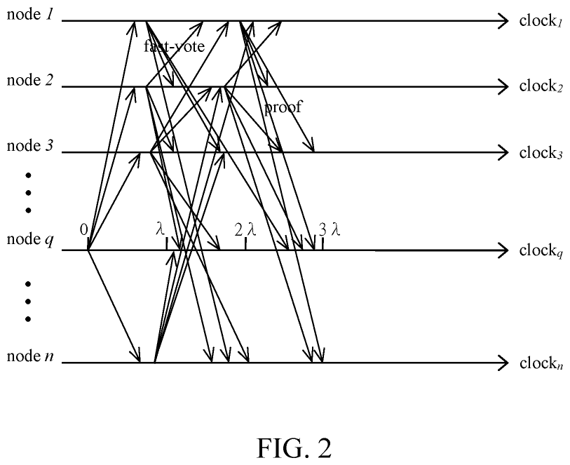

FIG. 2 illustrates an embodiment of a distributed system. There are n nodes, node 1, node 2, node 3, . . . , node n, respectively, in the distributed system. All nodes 1, 2, 3, . . . , n initially execute the Fast mode, where a single-phase Byzantine Agreement (Fast Byzantine Agreement) with a pre-determined leader is adopted. In the Fast mode, one easy way to select a pre-determined leader L, as an example, is q^{th} node of all node, where q=Hash(R₁, chain_{id}, height) mod N. Assume node q, selected as the pre-determined leader L, is an honest (not malicious) node, it will broadcast a value to all other nodes when clock_{q} is equal to 0. All other correct nodes receive node q's proposed value and reply in 2λ. Then, Once 2tₘₐₓ+1 fast-votes are achieved on the value proposed by node q, the value is confirmed and then a block B is decided when clock_{q} is less or equal to 3λ. Meanwhile, these correct nodes broadcast their share-signature(B) and terminate within 4λ. In other words, if some nodes decide in the Fast mode, these nodes would broadcast the proof, containing 2tₘₐₓ+1 signatures, and every node will decide on the value as soon as receiving the proof. Otherwise, nodes will enter the Safe mode, where a Robust Byzantine Agreement with a leader selected by fully sortition is adopted.

In the Robust Byzantine Agreement, if a node receives the proof of agreement from the Fast Byzantine Agreement, the node will broadcast the message of “fast-confirmed,” the block B, the proof of the agreement value and share-signature(B) and then terminate. Note that, a correct node only sends one share-signature(B) once, where B is either the block proposed in the Fast mode or the block decided in the safe mode.

### Robust Byzantine Agreement

Algorand's Agreement adopting a pure Proof-of-Stack (PoS) protocol may be easily used as the Robust Byzantine Agreement here because higher DDoS-resistance capacity is achieved.

Besides, some other Byzantine Agreements proposed based on the Algorand's Agreement may also be used as the Robust Byzantine Agreement here, such as a protocol stated below, which is also proposed by the same inventor of the present invention.

For each node qϵS, q has four internal variables: r_{q}, lockvalue_{q}, lockround_{q} and clock_{q}. Let sk_{q} and pk_{q} denote the secret key and public key of node q, respectively. The status is the public predictable information of the block (e.g., shard_{id}, chain_{id}, height, etc.). For the leader election, each node qϵS computes the signature σ_{g}=sig_{skq}(status) with its secret key sk_{q}. There are three kinds of messages:

1. the initial message of node q: (“initial”, v_{q}, q, σ_{q});

2. the pre-commit message of the value v from node q at the round r: (“pre-commit”, v, q, r);

3. the commit message of the value v from node q at the round r: (“commit”, v, q, r).

Let M_{q} denote the set of initial messages that node q receives from other nodes. Node q verifies the signatures in M_{q} and sets U_{q} to be the set of nodes whose signatures are valid. Then, node q computes

$$L = {arg min}_{j ∈ {U}_{q}} \vert {R}_{i} - Hash ( {σ}_{j} ) \vert .$$

The Robust Byzantine Agreement is a round-based protocol. Initially, for all correct nodes qϵS, node q initializes its internal variables by r_{q}=1, lockvalue_{q}=⊥, lockround_{q}=0 and clock_{q}=0 and also chooses its initial value v_{q}ϵV. There are four steps in each round. At Step 1, all the nodes broadcast their own initial value v_{q} in the format (“initial”, v_{q}, q, σ_{q}). When clock_{q}=2λ, node q enters Step 2. If lockvalue_{q}=⊥, node q verifies the initial messages it receives and computes the set U_{q} of nodes whose signatures are valid. If U_{q}≠0, q identifies its leader L and pre-commits Ls value; otherwise, node q pre-commits ⊥. If lockvalue_{q}≠⊥, node q pre-commits lockvalue_{q}. That is, node q pre-commits on a value v if node q broadcasts the message (“pre-commit”; v; q; r) where r is the round number that node q is working at. When clock_{q}=4λ, node q enters Step 3. If node q has seen 2tₘₐₓ+1 pre-commit messages of the same value vϵV∪{⊥L} at round r_{q}, node q updates lockvalue_{q}=v and lockround_{q}=r_{q} and commits v. Otherwise, node q commits SKIP. Note that node q must commit some value at Step 3. That is, node q commits on a value v if node q broadcasts the message (“commit”; v; q; r) where r is the round number that node q is working at. After node q broadcasts the commit-message, node q enters Step 4, at which node q waits for the forward conditions. In short, suppose the node q is working at round r_{q}. The node q updates its internal variables as soon as one of the following conditions holds:

1. If node q has seen 2tₘₐₓ+1 pre-commit messages of the same value vϵV∪{⊥} at the same round r such that r_{q}≥r>lockround_{q}, node q sets lockvalue_{q}=v and lockround_{q}=r.

2. (forward condition) If node q has seen 2tₘₐₓ+1 pre-commit messages of the same value vϵV∪{⊥} at the same round r such that r>r_{q}, node q sets clock_{q}=2λ, lockvalue_{q}=v, lockround_{q}=r and starts the round r from Step 2.

3. (forward condition) If the node q has seen 2tₘₐₓ+1 commit messages of any value at the same round r such that r≥r_{q}, q sets clock_{q}=2λ and starts the round r+1 from Step 2.

That is, node q achieves the forward condition, if the condition 2 or the condition 3 holds. Node q goes into the next round immediately if it achieves the forward condition even if it does not achieve the forward condition at Step 4. Node q decides on a value v as soon as node q has seen 2tₘₐₓ+1 commit messages of the same value vϵV∪{⊥} at the same round r.

Furthermore, in the present embodiment, even if the node q enters Safe mode, once node q sees a valid proof of the decision in the Fast Byzantine Agreement, node q terminates the Robust Byzantine Agreement and broadcast the proof and its share-signature on the value from the Fast Byzantine Agreement (called as backward condition).

In another aspect, the overall procedure of the Hybrid Byzantine Agreement protocol incorporated with Robust Byzantine Agreement protocol is summarized as below, that may provide better understanding of the present embodiment to those having ordinary skill in the art.

Procedure Hybrid Byzantine Agreement for node q
Input: an initial value v_{q}ϵV from node q who has own secret key sk_{q} and the threshold share secret key ssk_{q} and the public key {pk_{q}} from all nodes, and public randomness and information
Output: an agreed value v_{fin}ϵV∪{⊥} from some node
Identify the leader by the public randomness and information if node q is the leader then
   Step 1: when clock_{q}=0,
      broadcast(“fast”, v_{q}, q, σ_{q})
   Step 2: when clock_{q}≤3λ,
      if node q sees 2tₘₐₓ+1 fast-vote messages then decide block B
   Step 3: when clock_{q}>3λ,
      enter Safe mode
else //node q is not the leader
   Step 1: when clock_{q}≤2λ,
      if receiving leaders block then
      check then broadcast(“fast-vote”, v_{leader}, q, σ_{q})
   Step 2: when clock_{q}≥3λ,
      if node q sees 2tₘₐₓ+1 fast-vote messages then decide block B
   Step 3: when clock_{q}>3λ,
      enter Safe mode

Procedure Robust Byzantine Agreement for node q
Input: an initial value v_{q}ϵV from node q and the public key {pk_{q}} from all nodes
Output: an agreed value v_{fin}ϵV∪{⊥} from some node
Initialize r_{q}=1, lockvalue_{q}=⊥, lockround_{q}=0 and clock_{q}=0
Step 1: when clock_{q}=0,
   broadcast(“initial”; v_{q}; q; GO
Step 2: when clock_{q}=2λ,

if lockvalue_{q} = ⊥ and U_{q} ≠ Ø then

node q identifies its leader L at qs current view
broadcast(“pre-commit”, v_{leader}, q, r_{q})

else if lockvalue_{q} = ⊥ and U_{q} = Ø then

broadcast(“pre-commit”, ⊥, q, r_{q})

else

broadcast(“pre-commit”, lockvalue_{q}, q, r_{q})

Step 3: when clock_{q}=4λ,

if node q has seen 2tₘₐₓ+1 pre-commit messages of the
same value v∈V∪ {⊥} at round r_{q} then

lockvalue_{q} = v
lockroundq = r_{q}
broadcast(“commit”, v, q, r_{q})

else

broadcast(“commit”, SKIP, q, r_{q})

Step 4: when clock_{q}ϵ(4λ, ∞)
   wait until the forward condition is achieved

Procedure Decide for node q
if has not received message of (“fast-confirmed”, v, proof) then broadcast(“fast-confirmed”, v, proof),
   where proof contains 2tₘₐₓ+1 signatures
broadcast(share-signature(B)).

### Fork

When the network is partitioned, the Hybrid Byzantine Agreement protocol stated above might be forked, which means some nodes confirmed the block from the Fast mode, while some nodes confirmed the block from the Safe mode. This problem maybe solve by using notarizing information which is a threshold signature signed by 2tₘₐₓ+1 nodes. Only one of the blocks can be notarized. In the Fast mode, nodes send their share-signature immediately after receiving 2tₘₐₓ+1 votes (or the proof of 2tₘₐₓ+1 votes) of the fast commits. In the Safe mode, nodes also send their share-signature immediately after receiving 2tₘₐₓ+1 votes (or the proof of 2tₘₐₓ+1 votes) of fast commits and leave the Safe mode. Note that, nodes send their share-signature concurrently in commit phase. Thus, correct nodes would not send share-signature twice, and this ensures only one of these two blocks can get the threshold signature whose threshold is 2tₘₐₓ+1. Therefore, this ensures one and only one of the blocks may reach the threshold signature.

Additionally, those having ordinary skill in the art readily recognize that the disclosure described above can be utilized in a variety of devices, environments, and situations. Although the present invention is written with respect to specific embodiments and implementations, various changes and modifications may be suggested to one skilled in the art, such as the Robust Byzantine Agreement is not limited by the embodiment stated above, other Byzantine Agreement which may achieve higher DDoS-resistance capacity than the Fast Byzantine Agreement may be used in the present invention. Moreover, the Fast Byzantine Agreement is not limited by the embodiment stated above, either, other Byzantine Agreement which may achieve higher throughput than the Robust Byzantine Agreement may be used in the present invention. It is intended that the present disclosure encompass such changes and modifications that fall within the scope of the appended claims.

What is claimed is:

1. A method for building agreements among a plurality of nodes, the method comprising:
performing a first Byzantine Agreement protocol;
selecting a first leader node from the plurality of nodes;
broadcasting a fast message from the first leader node to all other nodes when a clock is equal to 0;
determining whether the first leader node decides a block according to a number of a plurality of fast-vote messages received from all other nodes by the first leader node and the value of the clock; and
performing a second Byzantine Agreement protocol if it is determined that the first leader node cannot decide a block.

2. The method of claim 1, wherein the first Byzantine Agreement protocol has a lower DDoS-resistance capacity and the second Byzantine Agreement protocol has a higher DDoS-resistance capacity.

3. The method of claim 1, wherein the first leader node is q^{th} node of the plurality of nodes, where q=Hash(Rᵢ, chain_{id}, height) mod N, where Rᵢ is a common reference string (CRS) at epoch i, chain_{id} is a series of chain name segments, and height is a block height.

4. The method of claim 1, wherein it is determined that the first leader node decides a block if the number of the plurality of fast-vote messages received by the first leader node amounts to 2tₘₐₓ+1 and the value of the clock is less than or equal to 3λ, where tₘₐₓ is a maximum size of malicious nodes, and λ is a upper bound of gossip time between two honest nodes.

5. The method of claim 1, wherein it is determined that another of the plurality of nodes decides a block if the number of the plurality of fast-vote messages received by the another of the plurality of nodes amount to 2tₘₐₓ+1 and the value of the clock is less than or equal to 3λ, where tₘₐₓ is a maximum size of malicious nodes, and λ is a upper bound of gossip time between two honest nodes.

6. The method of claim 1, wherein the step of performing the second Byzantine Agreement protocol further comprises:
having each one of the plurality of nodes have a plurality of internal variables, wherein the internal variables comprise r_{q}, lockvalue_{q}, lockround_{q} and clock_{q}, where r_{q} is an index of round at which a node q is working, lockvalue_{q} is candidate values that the node q supports, lockround_{q} is an index of round from which lockvalue_{q} comes and clock_{q} is a local clock of node q;
initializing respectively r_{q} as 1, lockvalue_{q} as ⊥, lockround_{q} as 0 and clock_{q} as 0, where ⊥ is a value not in a set of values that can be decided;
selecting a second leader node from the plurality of nodes;
having each one of the plurality of nodes broadcast an initial message to all other nodes when clock_{q} is equal to 0;
having each one of the plurality of nodes verify and compute the initial messages and broadcast a pre-commit message to all other nodes when clock_{q} is equal to 2λ, where λ is a upper bound of gossip time between two honest nodes; and
confirming whether the number of the pre-commit messages received by the one of the plurality of nodes amounts to 2tₘₐₓ+1 and one of variables included in the plurality of pre-commit messages is equal to Rᵢ when clock_{q} is equal to 4λ, where tₘₐₓ is a maximum size of malicious nodes and Rᵢ is a common reference string (CRS) at epoch i;
wherein the one of the plurality of nodes sets lockvalue_{q} as v and lockround_{q} as r_{q}, and broadcasts a commit message to all other nodes when clock_{q} is equal to 42 if the number of the plurality of pre-commit messages received by the one of the plurality of nodes amount to 2tₘₐₓ+1 and one of variables included by the plurality of pre-commit messages is equal to Rᵢ.

7. The method of claim 6, wherein the second leader node L is defined as:
$$L = {arg min}_{j ∈ {U}_{q}} \vert {R}_{i} - Hash ( {σ}_{j} ) \vert ,$$
where U_{q} is the set of nodes whose signatures are valid and σⱼ is a signature of status of the block, including some public predictable information, using a secret key of node j.

8. The method of claim 1, further comprising:
terminating the second Byzantine Agreement protocol and supporting the block decided by the first Byzantine Agreement protocol when a valid proof of decision in the first Byzantine Agreement protocol is received after the second Byzantine Agreement protocol is performed.

9. The method of claim 1, further comprising:
sending notarizing information which is a threshold signature signed by 2tₘₐₓ+1 nodes concurrently in a commit phase.

10. A distributed system comprises a plurality of nodes, wherein the plurality of nodes are configured to:
selecting a first leader node from the plurality of nodes according to a first Byzantine Agreement protocol, broadcasting a fast message from the first leader node to all other nodes when a clock is equal to 0;
receiving fast-vote messages from all other nodes at the first leader node;
deciding a block by the first leader node according to a number of the plurality of fast-vote messages and a value of the clock; and
performing a second Byzantine Agreement protocol if the first leader node cannot decide a block.

11. The distributed system of claim 10, wherein the first Byzantine Agreement protocol has a lower DDoS-resistance capacity and the second Byzantine Agreement protocol has a higher DDoS-resistance capacity.

12. The distributed system of claim 10, wherein the first leader node is q^{th} node of the plurality of nodes, where q=Hash(Rᵢ, chain_{id}, height) mod N, where Rᵢ is a common reference string (CRS) at epoch i, chain_{id} is a series of chain name segments, and height is a block height.

13. The distributed system of claim 10, wherein the plurality of nodes are further configured to: terminating the second Byzantine Agreement protocol and supporting the block decided by the first Byzantine Agreement protocol when a valid proof of decision in the first Byzantine Agreement protocol is received after the second Byzantine Agreement protocol is performed.

14. The distributed system of claim 10, wherein the plurality of nodes are further configured to: sending notarizing information which is a threshold signature signed by 2tₘₐₓ+1 nodes concurrently in a commit phase.
